(19) United States
(12) Patent Application Publication
(10) Pub. No.: US 2017/0108600 A1
(43) Pub. Date: Apr. 20, 2017

(54) METHODS AND SYSTEMS FOR A SEA-FLOOR SEISMIC SOURCE

(71) Applicant: CGG SERVICES SAS, Massy Cedex (FR)

(72) Inventors: François-Xavier GRESILLON, Rully (FR); Eric FORGUES, Bures-sur-Yvette (FR)

(21) Appl. No.: 15/312,344

(22) PCT Filed: May 19, 2015
(86) PCT No.: PCT/IB2015/000849

§ 371 Date: Nov. 18, 2016

Related U.S. Application Data
(60) Provisional application No. 62/000,556, filed on May 20, 2014.

(51) Int. Cl. G01V 1/155; G01V 1/02

(52) U.S. Cl. CPC G01V 1/155; G01V 1/159; G01V 1/38

(57) ABSTRACT

Systems and methods for a sea-floor seismic source are provided. The seismic source system includes a housing (102) having an internal cavity (104). The housing is configured to be coupled to a surface by gravity. The system further includes a coupling plate (106) fixed to a base (108) of the internal cavity. The coupling plate is configured to transmit energy through the base of the internal cavity and into the surface. The system also includes an excitation source (110) located in the internal cavity. The excitation source is configured to receive an input signal from a computing system communicatively coupled to the excitation source, and transmit energy to a reactive mass (112) located in the internal cavity and transmit energy to the coupling plate.

### CROSS-REFERENCE TO RELATED APPLICATION

This application claims the benefit under 35 U.S.C. §119(e) of U.S. Provisional Application Ser. No. 62/000,556 filed on May 20, 2014, which is incorporated by reference in its entirety for all purposes.

### TECHNICAL FIELD

This disclosure relates generally to seismic imaging of subsurface formations, and in particular, to methods and systems for a sea-floor seismic source.

### BACKGROUND

In recent years, offshore drilling has become an increasingly important method of locating and retrieving oil and gas. But because drilling offshore involves high costs and high risks, marine seismic surveys are used to produce an image of subsurface geological structures. Marine seismic surveys are usually accomplished using seismic sensors located below the water's surface or located on the sea-floor and seismic sources located below or near the water's surface (for example, an air gun, water gun, or marine vibrators). For example, seismic sensors may the placed using Ocean Bottom Cable (OBC) and/or Ocean Bottom Node (OBN) systems. Ocean bottom sensors are placed on the sea-floor. Each seismic sensor, or “sensor,” may be a geophone, hydrophone, accelerometer, distributed acoustic sensing (DAS) fiber, or any other sensor that detects signals from below the earth's surface.

For seismic surveys, the seismic source generates a seismic signal, which is a series of seismic waves that travel in various directions including below the earth's surface. The seismic waves penetrate the ocean floor and are at least partially reflected by interfaces between subsurface layers having different seismic wave propagation speeds. The reflected waves are received by a geophone, array of geophones, hydrophones, or sensors, located under water, at the sea-floor, or below the sea-floor, which allow measurement of the displacement of the ground resulting from the propagation of the waves. Sensors transform the seismic waves into seismic traces suitable for analysis. Sensors are in communication with a computer or recording system, which records the seismic traces from each sensor. A seismic trace thus represents the seismic waves received at a sensor from a source. The sensors record the time at which each reflected wave is received. The travel time from source to sensor, along with the velocity of the source wave, can be used to reconstruct the path of the waves to create an image of the subsurface.

Additionally, for reservoir monitoring (for example, repeat surveys to detect changes in a reservoir) two methods are in common use today, continuous 4D seismic monitoring and time-lapse 4D seismic monitoring. Both methods involve one or multiple sources and sensors that are in use for an extended period of time. In continuous 4D seismic monitoring, sources and sensors may continually operate for days, weeks, months or years to monitor changes in a reservoir or other subsurface formation. In time-lapse 4D seismic monitoring, sources and sensors repeat a seismic survey over a defined time interval. Each survey can be performed hours, days, weeks, months, or years apart.

In a typical continuous 4D seismic monitoring or time-lapse 4D seismic monitoring survey, a first survey is performed and serves as the baseline survey. Follow-on surveys are then performed at the same location at calendar intervals. In some cases, to perform the survey, sources are placed at the sea-floor and activated.

### SUMMARY

In accordance with some embodiments of the present disclosure, a seismic source system includes a housing having an internal cavity. The housing is configured to be coupled to a surface by gravity. The system further includes a coupling plate fixed to a base of the internal cavity. The coupling plate is configured to transmit energy through the base of the internal cavity and into the surface. The system also includes an excitation source located in the internal cavity. The excitation source is configured to receive an input signal from a computing system communicatively coupled to the excitation source, and transmit energy to a reactive mass located in the internal cavity and transmit energy to the coupling plate.

In accordance with another embodiment of the present disclosure, a method includes receiving an input signal from a computing system communicatively coupled to an excitation source. The excitation source is located in an internal cavity of a housing. The housing configured to be coupled to a surface by gravity. The method also includes transmitting energy to a reactive mass located in the internal cavity and transmitting energy to the coupling plate. The coupling plate is fixed to a base of the internal cavity. The coupling plate is configured to transmit energy through the base of the internal cavity and into the surface.

### BRIEF DESCRIPTION OF THE DRAWINGS

For a more complete understanding of the present disclosure and its features, reference is now made to the following description, taken in conjunction with the accompanying drawings, in which like reference numbers indicate like features and wherein:

FIGS. 1A and 1B illustrate schematic diagrams of seismic source systems in accordance with some embodiments of the present disclosure;

FIG. 2 illustrates an elevation view of a deployed seismic source system in accordance with some embodiments of the present disclosure;

FIG. 3 illustrates a flow chart of an example method for a sea-floor seismic source system in accordance with some embodiments of the present disclosure; and

FIG. 4 illustrates a schematic diagram of an example system that can be used for sea-floor seismic sources during a seismic survey in accordance with some embodiments of the present disclosure.

### DETAILED DESCRIPTION

The following description of the exemplary embodiments refers to the accompanying drawings. The same reference numbers in different drawings identify the same or similar elements.

Seismic exploration systems use one or more seismic sources to emit a seismic signal. The present disclosure contemplates the deployment of individual seismic sources onto the sea-floor from a platform, a ship, or other vessel. Each seismic source is configured to fall to and be coupled to the earth's surface by use of gravity. As such, each seismic source includes a housing of sufficient weight to provide the necessary coupling at the bottom of the body of water. Each housing includes a cavity that retains an excitation source, a reactive mass, and a coupling plate at the base of the cavity. Further, the base of the housing is of sufficient stiffness to allow transmission of energy from the reactive mass through the coupling plate and the housing base into the earth's surface. Deployment of the seismic sources may also include an anchoring device that may be coupled to a buoy. The buoy remains at the surface of the water to provide location information and, in some cases, transmission of data. The anchoring device of the seismic source may additionally be used to retrieve the seismic source back to the surface for use in future deployments.

As used herein, a hyphenated form of a reference numeral refers to a specific instance of an element and the un-hyphenated form of the reference numeral refers to the collective or generic element. Thus, for example, widget “72-1” refers to an instance of a widget class, which may be referred to collectively as widgets “72” and any one of which may be referred to generically as a widget “72”.

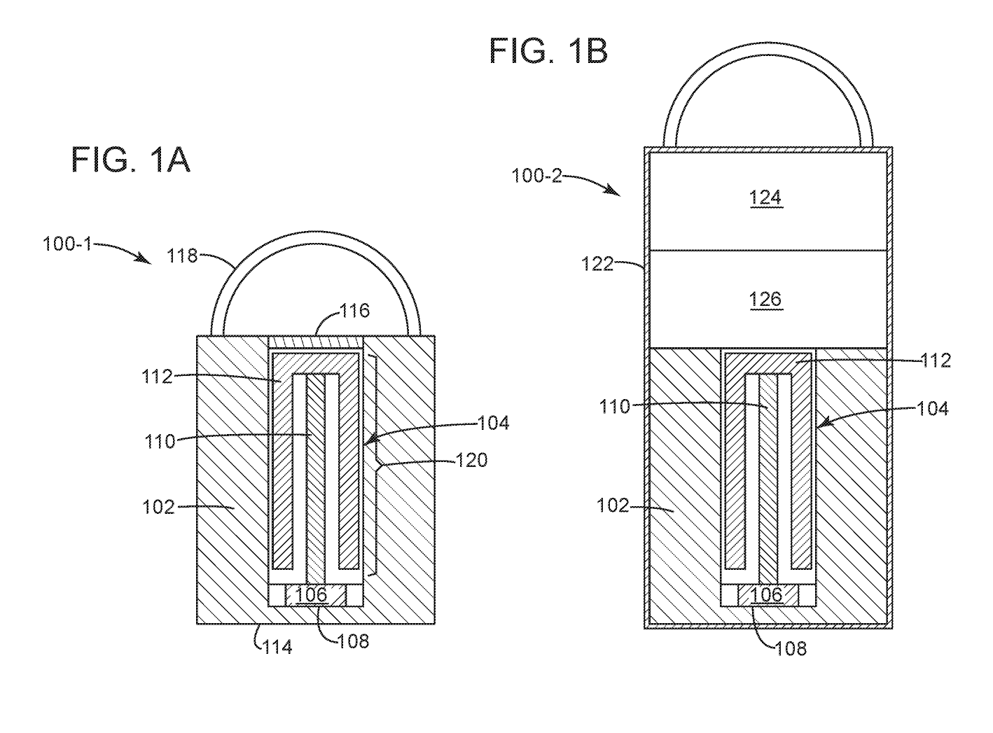

FIGS. 1A and 1B illustrate schematic diagrams of seismic source systems 100-1 and 100-2 in accordance with some embodiments of the present disclosure. Seismic source systems 100-1 and 100-2 (collectively referred to as “seismic source systems 100”) are configured to be deployed at the bottom of a body of water and be coupled to the earth's surface. In some embodiments, seismic source system 100 may be deployed in transition zone surveys, for example, in costal, marshy, or shallow water areas. Although described herein as water-based, the systems and methods of the present disclosure are equally applicable to use in a land-based seismic survey. Seismic source systems 100 include housing 102 that includes cavity 104, coupling plate 106 fixed to base 108 of cavity 104, and excitation source 110 and reactive mass 112 located in cavity 104.

Housing 102 is constructed of any material that provides sufficient weight such that system 100 is coupled with the ground. For example, housing 102 may be constructed of cement, metal, or any other suitable material. Housing 102 and other components of seismic source systems 100 are of sufficient weight to provide coupling between bottom surface 114 of housing 102 or seismic source systems 100 and the earth's surface due to gravity. Housing 102 may have any suitable exterior shape, such as, cubic, cylindrical, pyramidal, or any other appropriate shape based on the implementation.

Housing 102 includes cavity 104 that may be any size or shape of opening in housing 102 sized to fit components of seismic source systems 100. For example, cavity 104 may be a cylindrical opening in housing 102. Cavity 104 includes base 108. The thickness of the material of housing 102 between base 108 of cavity 104 and bottom surface 114 is configured to ensure a stiffness that allows an optimal transmission of force from excitation source 110 and reactive mass 112 to the earth's surface.

Housing 102 is configured to exclude water from entering cavity 104 or other internal areas. For example, FIG. 1A illustrates cap 116 that may be affixed to the top of cavity 104 to substantially prevent water from entering cavity 104. Cap 116 may be bonded, welded, sealed, or otherwise coupled to housing 102. As another example, FIG. 1B illustrates enclosure 122 that surrounds and seals housing 102 and other components of seismic source system 100-2 to exclude water from the interior of enclosure 122, for example, from entering cavity 104.

In some embodiments, cavity 104 includes coupling plate 106 affixed to base 108 of cavity 104 using any suitable bonding mechanism. Coupling plate 106 may be constructed of metal or other suitable material with sufficient stiffness. Coupling plate 106 is configured to transfer force from reactive mass 112 through base 108 and into the earth's surface.

Cavity 104 includes excitation source 110 and reactive mass 112, collectively referred to as seismic source 120. Excitation source 110 is any suitable source for generating seismic energy. Excitation source 110 may be coupled to coupling plate 106 or any other portion of cavity 104. Reactive mass 112 may be affixed to excitation source 110. Reactive mass 112 may be decoupled from other components in cavity 104 to allow a free motion of reactive mass 112. In some embodiments, a centering device, such as, a metallic centering disk, may be used to ensure centering of reactive mass 112 inside cavity 104. For example, excitation source 110 may be a piezoelectric pillar source and reactive mass 112 may be a cylindrical steel mass mounted on the pillar. In such a case, the piezoelectric pillar includes a ceramic pile fixed at the base to coupling plate 106. As additional examples, excitation source 110 may be an electrodynamic source or a magnetoresistive source.

When excitation source 110 is activated, such as, by a high voltage controller, energy is transferred to reactive mass 112. When reactive mass 112 is activated, force is transferred from reactive mass 112 to coupling plate 106. Because seismic source 120 is fixed to the bottom of housing 102, coupling between the earth's surface and seismic source 120 may be ensured. Although discussed with seismic source 120 consisting of a excitation source and reactive mass, any suitable seismic source may be configured within cavity 104.

Anchoring device 118 may be coupled to a surface of housing 102 or enclosure 122. For example, FIG. 1A illustrates anchoring device 118 coupled to a top surface of housing 102. FIG. 1B illustrates anchoring device 118 coupled to a top surface of enclosure 122. Anchoring device 118 may be any mechanism configured to allow for deployment and retrieval of seismic source systems 100. Anchoring device 118 may be any suitable material such as metal and may be coupled to housing 102 or enclosure 122 using any suitable method, such as welding or bonding. Further, although shown as an arch, anchoring device 118 may be of any suitable shape or structure.

In some embodiments, seismic source system 100 may be configured to be autonomous with on-board power, amplification, processing, and memory. FIG. 1B illustrates seismic source system 100-2 that includes power system 124 and computing system 126. Power system 124 may include any suitable components for providing power to excitation source 110 or other components of seismic source system 100-2. For example, power system 124 may include a set of batteries and a high voltage amplifier. Power system 124 may be capable of providing power for the duration of the seismic survey or reservoir monitoring operation. Computing system 126 may include any suitable components for controlling, monitoring, and activating excitation source 110 and storing data, such as, a processor and a memory.

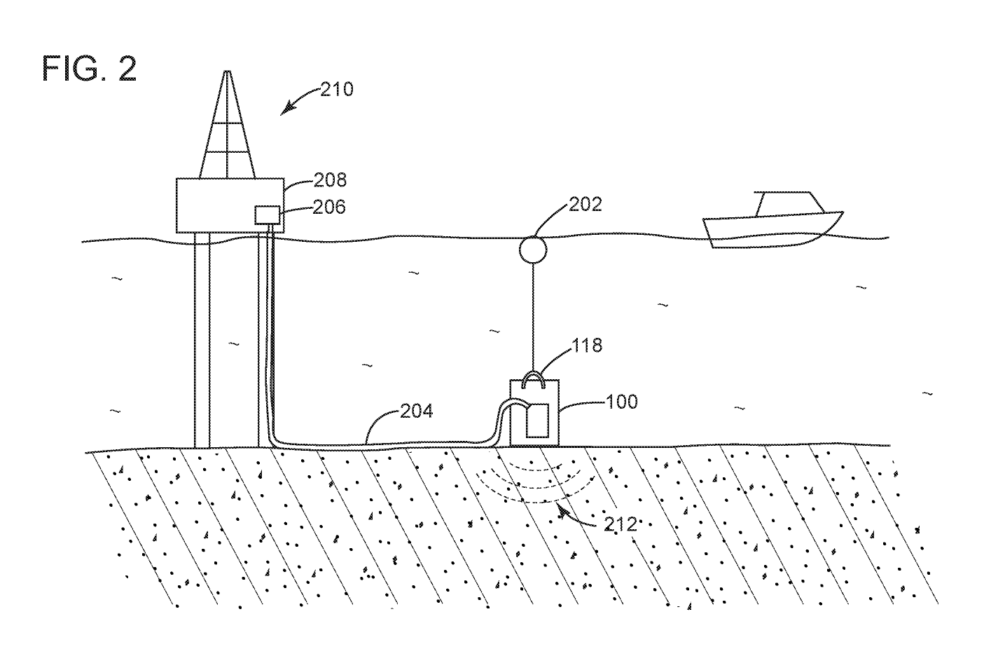

FIG. 2 illustrates an elevation view of a deployed seismic source system 100 in accordance with some embodiments of the present disclosure. When deployed, anchoring device 118 may be coupled to buoy 202, or other flotation device, that remains at or near the surface of the water. Buoy 202 may indicate the location of a particular seismic source system 100 and may assist in retrieval of seismic source system 100. Further, buoy 202 may include an antenna or other device for transmitting data or location services, such as a global positioning system (GPS, GLONASS, etc.) information. Seismic source system 100 can be deployed at any suitable depth. For example, seismic source system 100 may be deployed at approximately 1,000 meters or more. Buoy 202, or other flotation device, may further be configured to release from system 100 on demand or automatically after a pre-determined amount of time for retrieval.

In some embodiments, seismic source system 100 may be linked to another device that provides power and computing resources for seismic source system 100. FIG. 2 illustrates cable 204 linked to computing system 206 at platform 208 of rig 210. Computing system 206 may include any suitable components for controlling, monitoring, transmitting power, and activating excitation source 110 and storing data, such as, a processor and a memory. Although FIG. 2 illustrates cable 204 linked to computing system 206 at a platform of a rig, cable 204 may link seismic source system 100 to computing system 206 located on shore, on a vessel, or at any other suitable location per the particular implementation.

In some embodiments, following a seismic survey, buoy 202, or other flotation device, may assist in retrieving seismic source system 100. Seismic source system 100 may be retrieved to a vessel. In some embodiments, data stored in seismic source system 100 may be retrieved. Seismic source system 100 may then be re-deployed to a different or the same location based on the design of the seismic survey. In some embodiments, seismic source system 100 may remain in a particular location for an extended period of time for successive surveys.

During a survey, excitation source 110 is activated and energy is transmitted to reactive mass 112. The force generated by excitation source 110 and reactive mass 112 is transmitted through coupling plate 106 and bottom surface 114 into the earth's surface as seismic waves 212. Seismic waves 212 reflect from interfaces between geological layers. The reflected waves are received by seismic sensors. The resultant seismic data may be utilized to generate an image of subsurface formations, to gather information from the near surface, to monitor the status of a reservoir, to gather information regarding the water layer, or any other seismic information obtained with the generated waves. In some embodiments, multiple seismic source systems 100 may be coordinated. Such multiple seismic source systems 100 may be linked via cables to be activated in series, approximately simultaneously, in the same monitoring period, or individually.

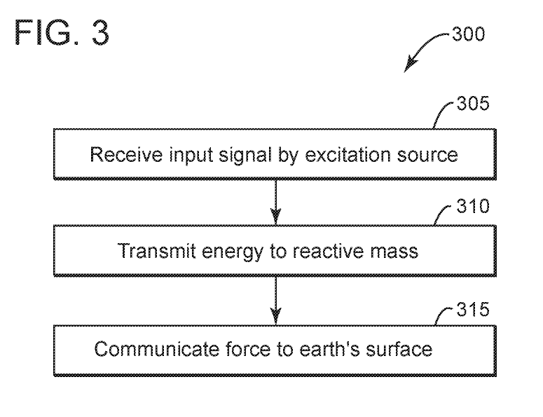

FIG. 3 illustrates a flow chart of an example method 300 for a sea-floor seismic source system in accordance with some embodiments of the present disclosure. The steps of method 300 are performed by a user, various computer programs, models configured to process or analyze geophysical data, and combinations thereof. The programs and models include instructions stored on a computer readable medium and operable to perform, when executed, one or more of the steps described below. The computer readable media includes any system, apparatus or device configured to store and retrieve programs or instructions such as a hard disk drive, a compact disc, flash memory, or any other suitable device. The programs and models are configured to direct a processor or other suitable unit to retrieve and execute the instructions from the computer readable media. For illustrative purposes, method 300 is described with respect to a seismic source system, such as, seismic source system 100 of FIGS. 1A, 1B, and 2.

At step 305, a seismic source system receives an input signal communicated to an excitation source. For example, seismic source system 100 may receive an input signal at excitation source 110 from computing system 126 or 206 discussed with reference to FIGS. 1B and 2, respectively. The computing system may also determine a location of a deployed seismic source system using GPS data received from a buoy or other source.

At step 310, the seismic source system transmits energy to a reactive mass from the excitation source. For example, excitation source 110 may transmit energy to reactive mass 112 based on the input signal received.

At step 315, the seismic source system communicates the force to the earth's surface. For example, excitation source 110 and reactive mass 112 may transmit force to coupling plate 106 that transmits the force through bottom surface 114 of seismic source system 100. The force may penetrate the earth's surface as seismic waves 212 discussed with reference to FIG. 2. Seismic waves 212 may reflect from interfaces between geological layers. The reflected waves may be received by seismic sensors. The resultant data may be utilized to generate an image of subsurface formations or to monitor the status of a reservoir, or to gather any other seismic information obtained with the generated waves (for example, information regarding the water layer).

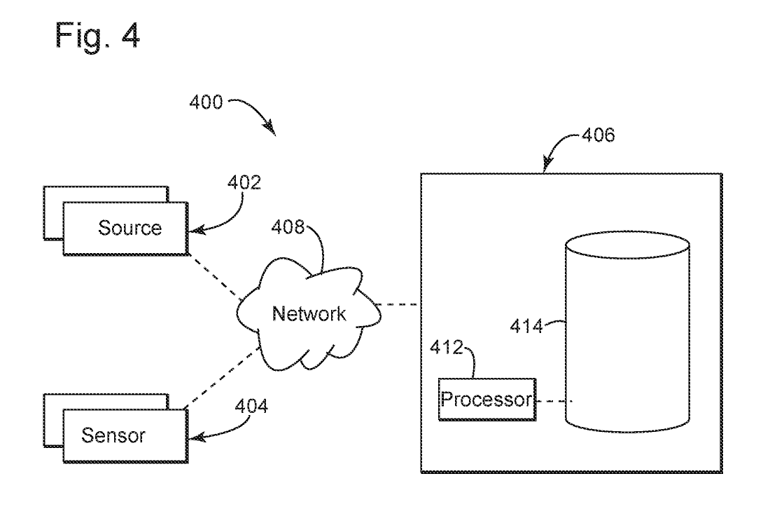

FIG. 4 illustrates a schematic diagram of an example system 400 that can be used for sea-floor seismic sources during a seismic survey in accordance with some embodiments of the present disclosure. System 400 includes one or more sources 402, one or more sensors 404, and computing system 406, which are communicatively coupled via one or more networks 408. Computing system 406 may include some or all components of computing system 126 or 206 discussed with reference to FIGS. 1B and 2, respectively. Further, source 402 may include some or all components of the seismic source system 100 discussed with reference to FIGS. 1A, 1B, and 2.

Computing system 406 can operate in conjunction with sources 402 and sensors 404 having any structure, configuration, or function. Sources 402 may include piezoelectric sources, magnetoresistive sources, or electrodynamic sources. Further, a positioning system, such as a global positioning system (GPS, GLONASS, etc.), may be utilized to locate or time-correlate sources 402 and sensors 404.

Sensors 404 may be any type of instrument that is operable to transform seismic energy or vibrations into a voltage signal. For example, sensors 404 may be a vertical, horizontal, or multicomponent geophone, hydrophone, accelerometers, or DAS fiber. Multiple sensors 404 may be utilized within an exploration area to provide data related to multiple locations and distances from sources 404. Sensors 404 may be positioned in multiple configurations, such as linear, grid, array, or any other suitable configuration.

Computing system 406 may include any instrumentality or aggregation of instrumentalities operable to compute, classify, process, transmit, receive, store, display, record, or utilize any form of information, intelligence, or data Computing system 406 may include random access memory (RAM), one or more processing resources such as a central processing unit (CPU) or hardware or software control logic, or other types of volatile or nonvolatile memory. Additional components of computing system 406 may include one or more disk drives, one or more network ports for communicating with external devices, various input and output (I/O) devices. Computing system 406 may be configured to permit communication over any type of network 408. Network 408 can be a wireless network, a local area network (LAN), a wide area network (WAN) such as the Internet, or any other suitable type of network.

Processor 412 communicatively couples to network interface 408 and memory 414 and controls the operation and administration of computing system 406 by processing information received from network interface 408 and memory 414. Processor 412 includes any hardware and/or software that operates to control and process information. In some embodiments, processor 412 may be a programmable logic device, a microcontroller, a microprocessor, any suitable processing device, or any suitable combination of the preceding. Computing system 406 may have any suitable number, type, and/or configuration of processor 412. Processor 412 may execute one or more sets of instructions to implement seismic surveys using seismic source systems. Processor 412 may also execute any other suitable programs to facilitate the generation of broadband composite images such as, for example, user interface software to present one or more GUIs to a user.

Memory 414 stores, either permanently or temporarily, data, operational software, or other information for processor 412, other components of computing system 406, or other components of system 400. Memory 414 includes any one or a combination of volatile or nonvolatile local or remote devices suitable for storing information. Computing system 406 may have any suitable number, type, and/or configuration of memory 414. Memory 414 may include any suitable information for use in the operation of computing system 406. For example, memory 414 may store computer-executable instructions operable to perform the steps discussed above with respect to FIG. 3 when executed by processor 412.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims. Moreover, while the present disclosure has been described with respect to various embodiments, it is fully expected that the teachings of the present disclosure may be combined in a single embodiment as appropriate.

Reference throughout the specification to “one embodiment,” “some embodiments,” or “an embodiment” means that a particular feature, structure or characteristic described in connection with an embodiment is included in at least one embodiment of the subject matter disclosed. Thus, the appearance of the phrases “in one embodiment,” “in some embodiments,” or “in an embodiment” in various places throughout the specification is not necessarily referring to the same embodiment. Further, the particular features, structures or characteristics may be combined in any suitable manner in one or more embodiments.

What is claimed is:

1. A seismic source system, comprising:
a housing having an internal cavity, the housing configured to be coupled to a surface by gravity;
a coupling plate fixed to a base of the internal cavity, the coupling plate configured to transmit energy through the base of the internal cavity and into the surface; and
an excitation source located in the internal cavity, the excitation source configured to:
receive an input signal from a computing system communicatively coupled to the excitation source; and
transmit energy to a reactive mass located in the internal cavity and transmit energy to the coupling plate.

2. The system of claim 1, wherein the excitation source is a piezoelectric source.

3. The system of claim 1, wherein the excitation source is a magnetoresistive source.

4. The system of claim 1, further comprising an anchoring device coupled to a top of the housing, the anchoring device configured for deployment or retrieval of the housing.

5. The system of claim 3, further comprising a flotation device coupled to the anchoring device.

6. The system of claim 1, further comprising a centering device coupled to the reactive mass, the centering device configured to center the reactive mass within the cavity.

7. The system of claim 1, wherein the computing system is remote from the housing and is coupled to the excitation source via a cable.

8. The system of claim 1, further comprising a power system communicatively coupled to the excitation source.

9. The system of claim 8, wherein the power system includes a battery and an amplifier coupled to the housing.

10. The system of claim 8, wherein the power system is remote from the housing and is communicatively coupled to the excitation source via a cable.

11. A method for a seismic source system comprising:
receiving an input signal from a computing system communicatively coupled to an excitation source, the excitation source located in an internal cavity of a housing, the housing configured to be coupled to a surface by gravity; and
transmitting energy to a reactive mass located in the internal cavity and transmitting energy to the coupling plate, the coupling plate fixed to a base of the internal cavity, the coupling plate configured to transmit energy through the base of the internal cavity and into the surface.

12. The method of claim 11, wherein the excitation source is a piezoelectric source.

13. The method of claim 11, wherein the excitation source is a magnetoresistive source.

14. The method of claim 11, wherein an anchoring device is coupled to a top of the housing, the anchoring device configured for deployment or retrieval of the housing.

15. The method of claim 13, wherein a flotation device is coupled to the anchoring device.

16. The method of claim 11, wherein a centering device is coupled to the reactive mass, the centering device configured to center the reactive mass within the cavity.

17. The method of claim 11, wherein the computing system is remote from the housing and is coupled to the excitation source via a cable.

18. The method of claim 11, wherein a power system is communicatively coupled to the excitation source.

19. The method of claim 18, wherein the power system includes a battery and an amplifier coupled to the housing.

20. The method of claim 18, wherein the power system is remote from the housing and is communicatively coupled to the excitation source via a cable.
